(19) United States
(12) Patent Application Publication
(10) Pub. No.: US 2021/0154876 A1
(43) Pub. Date: May 27, 2021

(54) YAM TWO-END REMOVING DEVICE

(71) Applicant: Binzhou University, Binzhou (CN)

(72) Inventors: Pengchuan LIU, Binzhou (CN); Jing LIU, Binzhou (CN); Jianmeng CAO, Binzhou (CN)

(21) Appl. No.: 17/165,798

(22) Filed: Feb. 2, 2021

Related U.S. Application Data
(63) Continuation of application No. PCT/CN2020/128938, filed on Nov. 16, 2020.

(30) Foreign Application Priority Data
Nov. 27, 2019 (CN) 201911182786.2

(51) Int. Cl. B26D 7/18; B26D 7/06

(52) U.S. Cl. CPC B26D 7/1818; B26D 2007/0018; B26D 7/0608; B26D 7/0625

(57) ABSTRACT

A yam two-end removing device includes: a conveying mechanism; a storage box arranged adjacent to and in coordination with the conveying mechanism; an accommodating portion arranged adjacent to and in coordination with the storage box; a first push-rod motor and a push plate connected to and coordinated with each other; a second push-rod motor and a vertical cutter connected to and coordinated with each other, arranged on one side of the push plate toward the accommodating portion; a third push-rod motor and a baffle connected to and coordinated with each other; a fourth push-rod motor and a horizontal cutter connected to and coordinated with each other; and a controller connected to the conveying mechanism, the first push-rod motor, the second push-rod motor, the third push-rod motor, and the fourth push-rod motor respectively. The advantages of the invention: both ends of yams with different lengths can be removed automatically and efficiently.

### CROSS-REFERENCE TO RELATED APPLICATIONS

This application is a continuation of International Application No. PCT/CN2020/128938 with a filling date of Nov. 16, 2020, designating the United states, now pending, and further claims to the benefit of priority from Chinese Application No. 201911182786.2 with a filing date of Nov. 27, 2019. The content of the aforementioned applications, including any intervening amendments thereto, are incorporated herein by reference.

### TECHNICAL FIELD

The present invention relates to the field of food processing machinery technologies, and particularly to a yam two-end removing device.

### BACKGROUND

In related arts, during processing of yams, two ends thereof are generally removed manually, and then the yams are automatically peeled and cleaned mechanically, or the yams are directly automatically peeled and cleaned mechanically without removing the two ends, which has the following technical defects:

(1) Manual removal of the two ends is inefficient, making it difficult to achieve automatic processing of the yams.

(2) Processing quality of the yams is easily affected if the two ends are not removed.

### SUMMARY OF THE INVENTION

The present invention is directed to solving at least one of the technical problems existing in the prior art or related art.

To this end, an objective of the present invention is to provide a device for removing two ends of yams.

To achieve the above objective, a technical solution of the present invention provides a yam two-end removing device, including: a rack; a conveying mechanism arranged on the rack; a storage box arranged adjacent to and in coordination with the conveying mechanism, a bottom surface of the storage box tilting downwards; an accommodating portion arranged adjacent to and in coordination with the storage box, a curved surface side of the accommodating portion being next to the bottom of the storage box for accommodating the yams, so as to cut two ends of the yam; a first push-rod motor and a push plate connected to and coordinated with each other, arranged on one semicircular opening side of the accommodating portion, the first push-rod motor being fixedly connected to the rack; a second push-rod motor and a vertical cutter connected to and coordinated with each other, arranged on one side of the push plate toward the accommodating portion, the vertical cutter being driven by the second push-rod motor to move up and down along a vertical direction to cut one end of the yam; a third push-rod motor and a baffle connected to and coordinated with each other, arranged on the other semicircular opening side of the accommodating portion, the third push-rod motor being fixedly connected to the rack, and a down-facing first photoelectric sensor being arranged in the top middle of the baffle; a fourth push-rod motor and a horizontal cutter connected to and coordinated with each other, arranged adjacent to the other semicircular opening side of the accommodating portion, the fourth push-rod motor being fixedly connected to the rack, the fourth push-rod motor pushing the horizontal cutter to move back and forth in a horizontal direction to cut away the other end of the yam, and the accommodating portion being provided with a cutter groove matching the horizontal cutter; and a controller connected to the conveying mechanism, the first push-rod motor, the second push-rod motor, the third push-rod motor, the first photoelectric sensor and the fourth push-rod motor respectively.

In this solution, with the coordination between the accommodating portion and the storage box, yams can slide out of the storage box one by one and enter the accommodating portion for removing two ends. Due to ingenious coordination of the first push-rod motor, the push plate, the third push-rod motor, the baffle, and the first photoelectric sensor, the two ends of yams with different lengths can be pushed to corresponding positions, which is conducive to the removal of the two ends of the yams with different lengths. The two ends of the yams are cut away by the second push-rod motor and the vertical cutter as well as the fourth push-rod motor and the horizontal cutter.

In this solution, the bottom surface of the storage box tilting downwards is further conducive to the yam sliding out of the storage box and entering accommodating portion, which further improves the efficiency of removing the two ends of the yam.

Specifically, the conveying mechanism conveys the yam into the storage box, the yam slides out from the storage box and enter the accommodating portion, and then, the first push-rod motor drives the push plate to move forward, the push plate pushes the yam in the accommodating portion to move forward; when a front end of the yam hits the baffle, the first photoelectric sensor detects a signal and transfers the signal to the controller, the controller controls the first push-rod motor to stop, and controls the second push-rod motor to drive the vertical cutter to move downward. At the same time, the controller controls the fourth push-rod motor to drive the horizontal cutter to move forward horizontally and the vertical cutter and the horizontal cutter cut off a small piece of two ends of the yam respectively. The cutting length of the two ends of the yam is fixed. Upon completion of the cutting, the controller controls the fourth push-rod motor to drive the horizontal cutter to reset, the controller controls the third push-rod motor to drive the baffle to reset, and then, the controller controls the first push-rod motor to drive the vertical cutter to push the yam to continuously move forward. The cut front end of the yam is pushed out of the accommodating portion, and then, the yam is pushed out for other processing or collection, and the controller controls the first push-rod motor to drive the push plate back. On the return trip, the vertical cutter pulls a cut back end of the yam back and drops it out from the accommodating portion. Then, the vertical cutter is reset, and the conveying mechanism continues to work repeatedly, enabling another yam to fall into the storage box, so as to continuously repeat the above working process.

Preferably, the accommodating portion includes: two rotating semi-cylindrical panels welded opposite to each other on a plain shaft, the plain shaft being rotatably connected to the rack; a stepping motor connected to the plain shaft, the stepping motor driving the plain shaft to rotate to drive the rotating semi-cylindrical panels to rotate, and the stepping motor being fixedly connected to the rack; and a pressing plate fixedly connected to edges of the two rotating semi-cylindrical panels opposite to the conveying mechanism; and the yam two-end removing device further includes: an isolation plate arranged between the storage box and the accommodating portion, a spring loop bar being sleeved with a horizontal end of the isolation plate and being fixedly connected to the rack, the spring loop bar being sleeved with a spring, and a top end of the spring being in contact with the isolation plate.

In this solution, with ingenious coordination of the stepping motor, the plain shaft, the rotating semi-cylindrical panels, the pressing plate, and the isolation plate, yams can slide out of the storage box one by one and enter the rotating semi-cylindrical panels for removing the two ends of the yams. It should be noted that the rotating semi-cylindrical panels may be rotating semi-cylindrical iron plates. The stepping motor stops after each rotation of 180 degrees. The stopping time of the stepping motor can be preset according to an actual production requirement.

Preferably, the yam two-end removing device further includes: a support plate fixedly connected to a lower part of the push plate, the support plate being perpendicular to the push plate and extending toward the accommodating portion along the horizontal direction, a height of an extension section of the support plate from the push plate to the accommodating portion being lower than a bottom surface of the accommodating portion, and a horizontal length of the extension section being greater than a horizontal distance from the vertical cutter to the push plate.

In this solution, when the vertical cutter cuts away the ends of the yam, the support plate fixedly connected to a lower part of the push plate moves to the bottom surface of the rotating semi-cylindrical panel, which can support the rotating semi-cylindrical panel, prevent the rotating semi-cylindrical panel from moving due to pressing by the vertical cutter, and improve the stability and reliability of removing ends of the yam.

Preferably, the yam two-end removing device further includes: a second photoelectric sensor fixedly connected to the rack and oriented toward the support plate.

In this solution, with the second photoelectric sensor, when resetting of the support plate is detected, the stepping motor can be started to drive the rotating semi-cylindrical panel to rotate, which further improves the efficiency of the two-end removal.

Preferably, the yam two-end removing device further includes: a first yam end collection box arranged below a gap between the push plate and one semicircular opening side, the first yam end collection box being detachably connected to the rack; and a second yam end collection box arranged below the other semicircular opening side, the second yam end collection box being detachably connected to the rack.

Alternatively, the yam two-end removing device further includes: a yam end collection box arranged below the accommodating portion, the two ends of the yam end collection box exceed the two ends of the accommodating portion to collect the yam ends pushed down from both ends of the accommodating portion, the yam end collection box being detachably connected to the rack.

In this solution, the removed ends of the yams can be collected by the yam end collection box, which, on the one hand, is conducive to waste recycling, and on the other hand, facilitates cleaning and removal of the ends of the yams.

Preferably, the conveying mechanism includes: a conveying motor and rollers arranged in coordination, fixedly connected to the rack, the two rollers being arranged at intervals, and the conveying motor being connected to one of the rollers; a conveyor belt, with which the roller is sleeved, the conveying motor driving the roller to rotate, so as to drive the conveyor belt for transmission, and the conveyor belt being arranged in coordination with the storage box to convey the yam into the storage box.

In this solution, the coordination of the conveying motor, the roller, the conveyor belt, or the like realizes automatic convey of the yams with a high automation degree of conveying and high conveying efficiency.

Preferably, the conveying mechanism further includes: a plurality of partitions arranged at intervals on the conveyor belt; and a third photoelectric sensor arranged on a lower side of the roller adjacent to the storage box, the third photoelectric sensor being oriented toward a bottom part of the conveyor belt, and a vertical distance between the third photoelectric sensor and the lowest surface of the conveyor belt being lower than the height of the partitions.

In this solution, the arrangement of a plurality of partitions and a third photoelectric sensor can ensure that one yam is transferred into the storage box at a time, which facilitates the removal of the two ends of the yams, and further improves the operability, degree of automation and efficiency of the two-end removing process.

The working process of the yam two-end removing device is as follows.

Specifically, a single yam is placed between two adjacent partitions, and the third photoelectric sensor controls a conveying distance of the conveyor by detecting the partitions on the conveyor belt. When detecting a signal, the third photoelectric sensor controls the conveyor belt to stop upon a delay of 1 second, thus controlling the conveyor belt to tilt every time one yam is conveyed forwards so as to ensure that the yam slips into the storage box. The stepping motor drives the rotating semi-cylindrical panel to rotate clockwise. With the rotation of the rotating semi-cylindrical panel, the pressing plate on the rotating semi-cylindrical panel comes into contact with a horizontal end of the isolation plate. With the continuous rotation of the rotating semi-cylindrical panel, the isolation plate moves down, and the yam in the storage box slides into the rotating semi-cylindrical panel. When the isolation plate is lower than the storage box, the stepper motor stops; that is, the stepper motor stops after rotating by 180 degrees clockwise. In this case, the push plate and the baffle are both tangent to the rotating semi-cylindrical panel. Then, the first push-rod motor drives the push plate to move forward. The push plate drives the yam inside the rotating semi-cylindrical panel to move forward, and at the same time, drives the support plate to move forward to provide support at the bottom of the rotating semi-cylindrical panel, so as to prevent the rotating semi-cylindrical panel from moving when the vertical cutter cuts downward. When a front end of the yam hits the baffle, the first photoelectric sensor detects a signal and controls the first push-rod motor to stop, and the second push-rod motor drives the vertical cutter to move downward. At the same time, the fourth push-rod motor drives the horizontal cutter to move forward horizontally to cut off a small piece of two ends of the yam. The cutting length of the two ends of the yam is fixed. Upon completion of the cutting, the fourth push-rod motor drives the horizontal cutter to reset, the third push-rod motor drives the baffle to reset, and then, the first push-rod motor drives the vertical cutter to push the yam to continuously move forward. The cut front end of the yam is pushed into the second yam end collection box, and then the yam is pushed out for other processing or collection. Then, the first push-rod motor drives the push plate back. On the return trip, the vertical cutter pulls a cut back end of the yam back and drops it into the first yam end collection box, the vertical cutter is reset, and the support plate is reset. When resetting of the support plate is detected by the second photoelectric sensor, the stepping motor continues to rotate by 180 degrees. During rotation of the stepping motor, the isolation plate rises. At the same time, a delay of 3 seconds is generated when the second photoelectric sensor detects that the support plate is reset, and the conveying mechanism continues to work repeatedly, achieving that another yam falls into the storage box and the above working process continues to be repeated.

With the above technical solutions, the conveying mechanism, the storage box, the accommodating portion, the photoelectric sensor, the push-rod motor, the cutter or the like are arranged in coordination with each other to remove the two ends of yams with different thicknesses and lengths automatically and efficiently. The yam two-end removing device according to the present invention can cooperate with the existing peeling and cleaning devices to realize the mechanized and automatic processing of yam, which is beneficial to improve the processing quality of yam, and the removed ends can also be reused, which saves resources to a certain extent.

Some of the additional aspects and advantages of the present invention will be given in the following description, and some will become apparent from the description below or be known through the practice of the present invention.

### BRIEF DESCRIPTION OF DRAWINGS

The above and/or additional aspects and advantages of the present invention will become apparent and easily understood from the description of embodiments with reference to the accompanying drawings below. In the drawings,

FIG. 1 is a schematic structural diagram of a yam two-end removing device according to an embodiment of the present invention;

FIG. 2 is a front view of the yam two-end removing device in FIG. 1;

FIG. 3 is a left view of the yam two-end removing device in FIG. 1;

FIG. 4 is a top view of the yam two-end removing device in FIG. 1;

FIG. 5 is a schematic structural diagram of a yam two-end removing device according to an embodiment of the present invention;

FIG. 6 is a schematic enlarged view of A in FIG. 5;

FIG. 7 is a schematic enlarged view of B in FIG. 5; and

FIG. 8 is a schematic structural diagram of an isolation plate in FIG. 1.

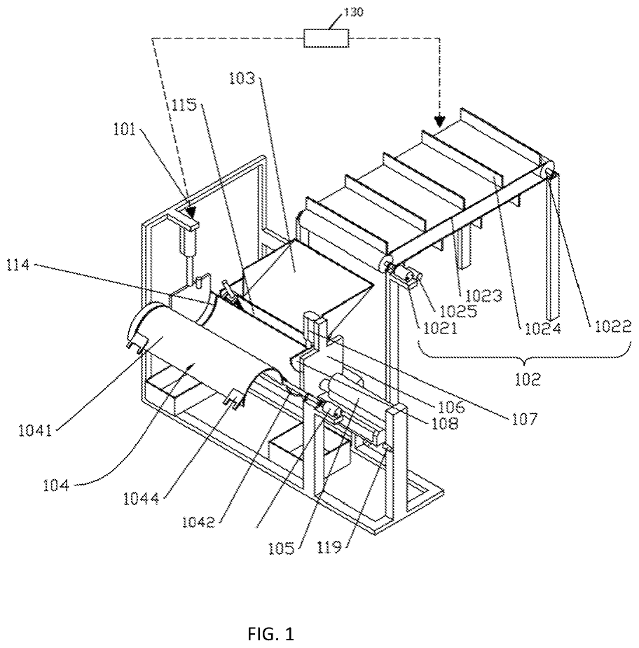

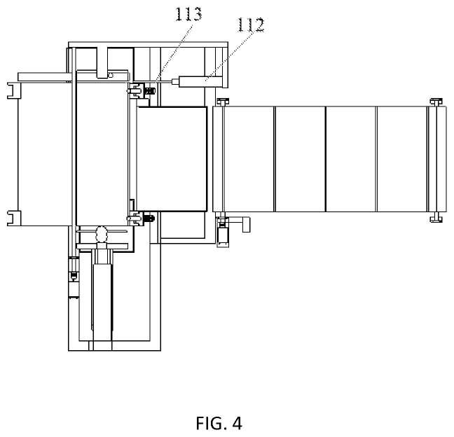

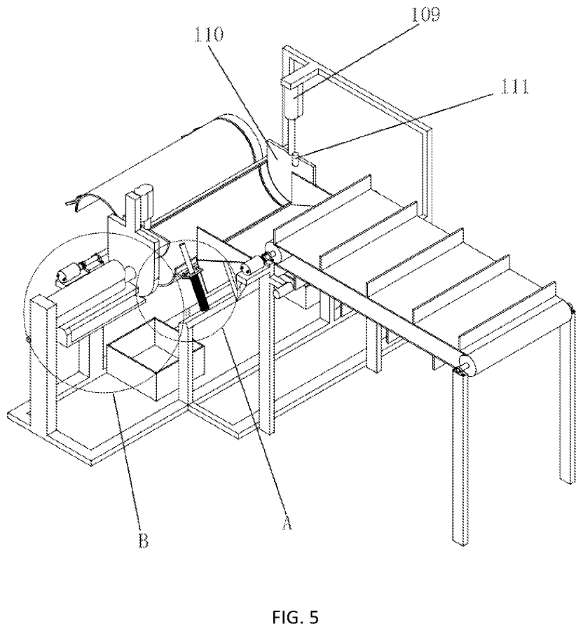

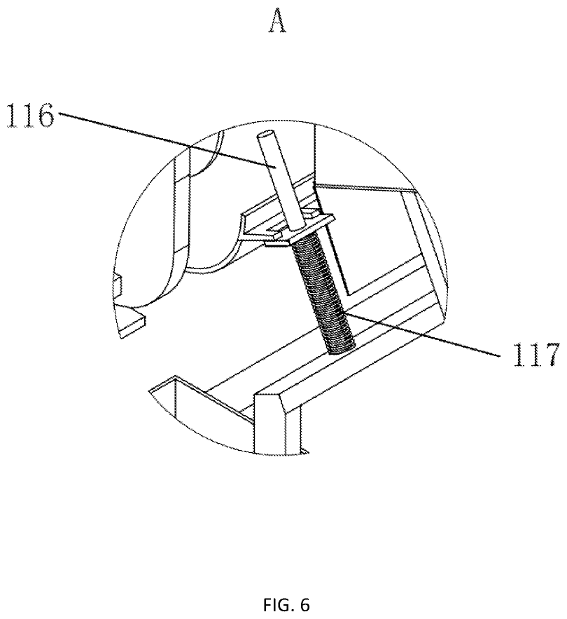

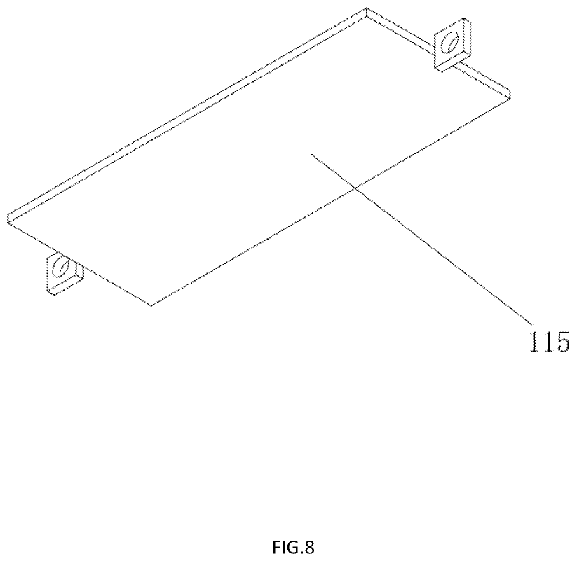

Correspondences between reference numerals and components in FIG. 1 to FIG. 8 are as follows:

101 rack, 102 conveying mechanism, 1021 conveying motor, 1022 roller, 1023 conveyor belt, 1024 partition, 1025 third photoelectric sensor, 103 storage box, 104 accommodating portion, 1041 rotating semi-cylindrical panel, 1042 plain shaft, 1043 stepping motor, 1044 pressing plate, 105 first push-rod motor, 106 push plate, 107 second push-rod motor, 108 vertical cutter, 109 third push-rod motor, 110 baffle, 111 first photoelectric sensor, 112 fourth push-rod motor, 113 horizontal cutter, 114 cutter groove, 115 isolation plate, 116 spring loop bar, 117 spring, 118 support plate, 119 second photoelectric sensor, 120 first yam end collection box, 121 second yam end collection box, 130 controller.

### DETAILED DESCRIPTION OF PREFERRED EMBODIMENTS

In order to better understand the objectives, features, and advantages of the present invention, the present invention is described below in further detail with reference to the accompanying drawings and specific implementations. It should be noted that without a conflict, the embodiments of this application and the features in the embodiments may be combined with each other.

Many specific details are set forth in the following description to facilitate a full understanding of the present invention. However, the present invention may be implemented in other manners other than those described herein. Therefore, the protection scope of the present invention is not limited by the specific embodiments disclosed below.

A yam two-end removing device according to an embodiment of the present invention is specifically described below with reference to FIG. 1 to FIG. 8. As shown in FIGS. 1 to 5, a yam two-end removing device includes: a rack 101 for fixing each structure, further including a conveying mechanism 102 arranged on a rack 101; a storage box 103 arranged adjacent to and in coordination with the conveying mechanism 102; an accommodating portion 104 arranged adjacent to and in coordination with the storage box 103, the storage box 103 being a tilting groove with a “U”-shaped cross section, an upper opening of the storage box 103 receiving the conveying mechanism, from which the yam falling into the groove, a lower opening of the groove being provided with an isolation plate 115 movable up and down, when the isolation plate 115 moving downwards, the yam entering the accommodating portion 104 from the storage box 103, the accommodating portion 104 being formed by two rotating semi-cylindrical panels 1041 with a curved surface being symmetrically welded on the plain shaft 1042 reversely, a curved surface side of the accommodating portion 104 being next to the bottom of the storage box 103 for accommodating the yams to cut away two ends of the yam; a first push-rod motor 105 and a push plate 106 connected to and coordinated with each other, arranged on one semicircular opening side of the accommodating portion 104, the first push-rod motor 105 being a linear motor with an operating stroke of 300 mm, the first push-rod motor 105 being fixedly connected to the rack 101; a second push-rod motor 107 and a vertical cutter 108 connected to and coordinated with each other, arranged on one side of the push plate 106 toward the accommodating portion 104, the vertical cutter 108 being driven by the second push-rod motor 107 to move up and down along a vertical direction to cut one end of the yam; a third push-rod motor 109 and a baffle 110 connected to and coordinated with each other, arranged on the other semicircular opening side of the accommodating portion 104, the third push-rod motor 109 being fixedly connected to the rack 101, and a down-facing first photoelectric sensor 111 being arranged in the top middle of the baffle 110; a fourth push-rod motor 112 and a horizontal cutter 113 connected to and coordinated with each other, arranged adjacent to the other semicircular opening side of the accommodating portion 104, the fourth push-rod motor 112 being fixedly connected to the rack 101, the fourth push-rod motor 112 pushing the horizontal cutter 113 to move back and forth in a horizontal direction to cut away the other end of the yam, and the accommodating portion 104 being provided with a cutter groove 114 matching the horizontal cutter 113, the cutter groove 114 being of a groove structure penetrating through a main structure of the accommodating portion 104, the horizontal cutter 113 passing through the cutter groove 114 to cut the end of the yam when being fed; and a controller 130, connected to the conveying mechanism 102, the first push-rod motor 105, the second push-rod motor 107, the third push-rod motor 109, the first photoelectric sensor 111 and the fourth push-rod motor 112 respectively.

In this embodiment, with the coordination between the accommodating portion 104 and the storage box 103, yams can slide out of the storage box 103 one by one and enter the accommodating portion 104 for removing two ends. Due to ingenious coordination of the first push-rod motor 105, the push plate 106, the third push-rod motor 109, the baffle 110, and the first photoelectric sensor 111, the two ends of yams with different lengths can be pushed to corresponding positions, which is conducive to the removal of the two ends of the yams with different lengths. The two ends of the yams are cut away by the second push-rod motor and the vertical cutter 108 as well as the fourth push-rod motor and the horizontal cutter 113.

Specifically, the conveying mechanism 102 conveys the yam into the storage box 103, the yam slides out from the storage box 103 and enter the accommodating portion 104, and then, the first push-rod motor 105 drives the push plate 106 to move forward, the push plate 106 pushes the yam in the accommodating portion 104 to move forward; when a front end of the yam hits the baffle 110, the first photoelectric sensor 111 detects a signal and controls the first push-rod motor 105 to stop, and the second push-rod motor 107 drives the vertical cutter 108 to move downward. At the same time, the fourth push-rod motor 112 drives the horizontal cutter 113 to move forward horizontally to cut off a small piece of two ends of the yam. The cutting length of the two ends of the yam is fixed. Upon completion of the cutting, the fourth push-rod motor 112 drives the horizontal cutter 113 to reset, the horizontal cutter 113 and the vertical cutter 108 are fed and retracted continuously, and reset after completion of feed movement. The third push-rod motor 109 drives the baffle 110 to reset, and then, the first push-rod motor 105 drives the vertical cutter 108 to push the yam to continuously move forward. The cut front end of the yam is pushed out of the accommodating portion 104, and then the yam is pushed out for other processing or collection, and the first push-rod motor 105 drives the push plate 106 back. On the return trip, the vertical cutter 108 pulls a cut back end of the yam back and drops it out from the accommodating portion 104. Then, the vertical cutter 108 is reset, and the conveying mechanism 102 continues to work repeatedly, enabling another yam to fall into the storage box 103, so as to continuously repeat the above working process. As shown in FIG. 1 and FIGS. 6 to 8, the accommodating portion 104 includes:

two rotating semi-cylindrical panels 1041 welded opposite to each other on a plain shaft 1042, the plain shaft 1042 being rotatably connected to the rack 101; a stepping motor 1043 connected to the plain shaft 1042, the stepping motor 1043 driving the plain shaft 1042 to rotate to drive the rotating semi-cylindrical panels 1041 to rotate, and the stepping motor 1043 being fixedly connected to the rack 101; and a pressing plate 1044 fixedly connected to two edges of the two rotating semi-cylindrical panels 1041 opposite to the conveying mechanism 102; and the yam two-end removing device further includes: an isolation plate 115 arranged between the storage box 103 and the accommodating portion 104, a spring loop bar 116 being sleeved with a horizontal end of the isolation plate 115 and being fixedly connected to the rack 101, the spring loop bar 106 being sleeved with a spring 117, and a top end of the spring 117 being in contact with the isolation plate 115.

In this embodiment, with ingenious coordination of the stepping motor 1043, the plain shaft 1042, the rotating semi-cylindrical panels 1041, the pressing plate 1044, and the isolation plate 115, or the like, yams can slide out of the storage box 103 one by one and enter the rotating semi-cylindrical panels 1041 for removing the two ends of the yams. It should be noted that the rotating semi-cylindrical panels 1041 may be rotating semi-cylindrical iron plates. The stepping motor 1043 stops after each rotation of 180 degrees. The stopping time of the stepping motor 1043 can be preset according to an actual production requirement.

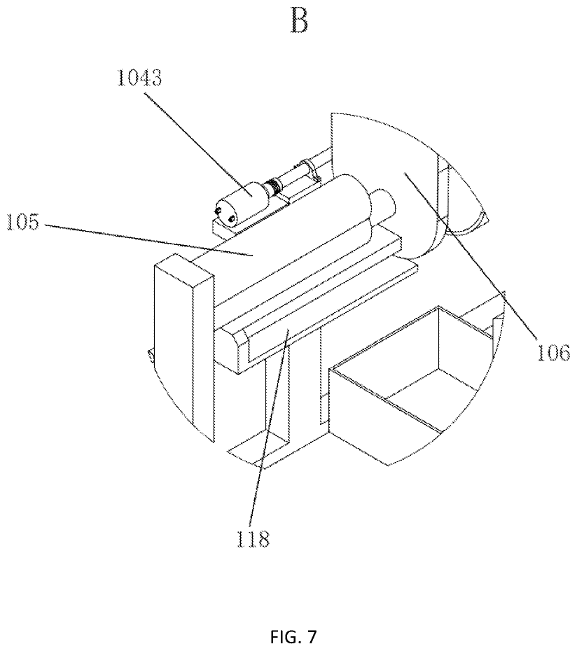

As shown in FIG. 1 and FIG. 7, the yam two-end removing device further includes: a support plate 118 fixedly connected to a lower part of the push plate 106, the support plate 118 being perpendicular to the push plate 106 and extending toward the accommodating portion 104 along the horizontal direction, a height of an extension section of the support plate 118 from the push plate 106 to the accommodating portion 104 being lower than a bottom surface of the accommodating portion 104, and a horizontal length of the extension section being greater than a horizontal distance from the vertical cutter 108 to the push plate 106.

In this embodiment, when the vertical cutter 108 cuts away the ends of the yam, the support plate 118 fixedly connected to a lower part of the push plate 106 moves to the bottom surface of the rotating semi-cylindrical panel 1041, which can support the rotating semi-cylindrical panel, prevent the rotating semi-cylindrical panel from moving due to pressing by the vertical cutter 108, and improve the stability and reliability of removing ends of the yam.

As shown in FIG. 1, the yam two-end removing device further includes: a second photoelectric sensor 119 fixedly connected to the rack 101 and oriented toward the support plate 118.

In this embodiment, with the second photoelectric sensor 119, when resetting of the support plate 118 is detected, the stepping motor 1043 can be started to drive the rotating semi-cylindrical panel 1041 to rotate, which further improves the efficiency of the two-end removal.

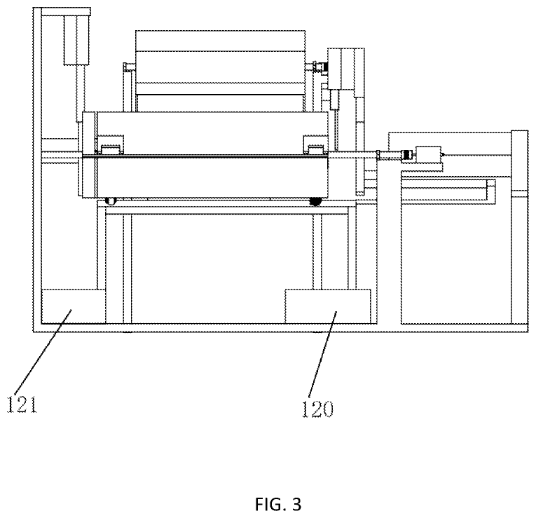

As shown in FIG. 1 and FIG. 3, the yam two-end removing device further includes: a first yam end collection box 120 arranged below a gap between the push plate 106 and one semicircular opening side, the first yam end collection box 120 being detachably connected to the rack 101; and a second yam end collection box 121 arranged below the other semicircular opening side, the second yam end collection box 121 being detachably connected to the rack 101.

In addition, the yam two-end removing device can further include: a yam end collection box arranged below the accommodating portion 104, the two ends of the yam end collection box exceed the two ends of the accommodating portion 104 to collect the yam ends pushed down from both ends of the accommodating portion 104, the yam end collection box being detachably connected to the rack 101.

In this embodiment, the removed ends of the yams can be collected by the yam end collection box, which, on the one hand, is conducive to waste recycling, and on the other hand, facilitates cleaning and removal of the ends of the yams.

As shown in FIG. 1, the bottom surface of the storage box 103 tilts downwards.

In this embodiment, the bottom surface of the storage box 103 tilting downwards is further conducive to the yam sliding out of the storage box 103 and entering accommodating portion 104, which can further improve the efficiency of removing the ends of the yam.

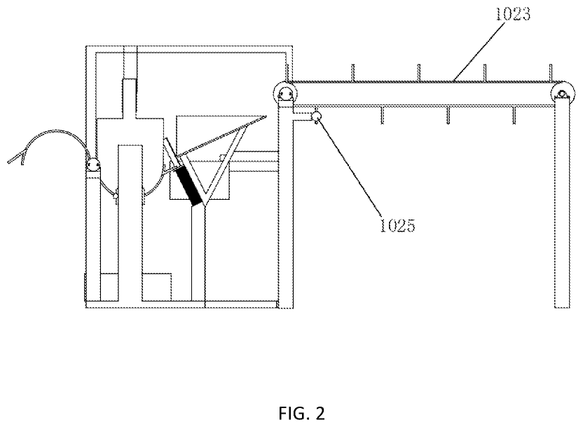

As shown in FIG. 1 and FIG. 2, the conveying mechanism 102 includes: a conveying motor 1021 and rollers 1022 arranged in coordination, fixedly connected to the rack 101, the two rollers 1022 being arranged at intervals, and the conveying motor 1021 being connected to one of the rollers 1022; a conveyor belt 1023, with which the roller 1022 is sleeved, the conveying motor 1021 driving the roller 1022 to rotate, so as to drive the conveyor belt 1023 for transmission, and the conveyor belt 1023 being arranged in coordination with the storage box 103 to convey the yam into the storage box 103.

In this embodiment, the coordination of the conveying motor 1021, the roller 1022, the conveyor belt 1023, or the like realizes automatic convey of the yams with a high automation degree of conveying and high conveying efficiency.

As shown in FIG. 1 and FIG. 2, the conveying mechanism 102 further includes: a plurality of partitions 1024 arranged at intervals on the conveyor belt 1023; and a third photoelectric sensor 1025 arranged on a lower side of the roller 1022 adjacent to the storage box 103, the third photoelectric sensor 1025 being oriented toward a bottom part of the conveyor belt 1023, and a vertical distance between the third photoelectric sensor 1025 and the lowest surface of the conveyor belt 1023 being lower than the height of the partitions 1024.

In this embodiment, the arrangement of a plurality of partitions 1024 and a third photoelectric sensor 1025 can ensure that one yam is transferred into the storage box 103 at a time, which facilitates the removal of the two ends of the yams, and further improves the operability, degree of automation and efficiency of the two-end removing process.

The working process of the yam two-end removing device is as follows.

A single yam is placed between two adjacent partitions 1024, and the third photoelectric sensor 1025 controls a conveying distance of the conveyor by detecting the partitions 1024 on the conveyor belt 1023. When the third photoelectric sensor 1025 detects a signal and transfers the signal to the controller 130, the controller 130 controls the conveyor belt 1023 to stop upon a delay of 1 second, thus controlling the partition 1024 at the end of the conveyor belt 1023 to tilt by the controller 130 every time one yam is conveyed forwards so as to ensure that the yam slips into the storage box 103 along the partition 1024. The stepping motor 1043 drives the rotating semi-cylindrical panel 1041 to rotate clockwise. With the rotation of the rotating semi-cylindrical panel 1041, the pressing plate 1044 on the rotating semi-cylindrical panel 1041 comes into contact with a horizontal end of the isolation plate 115. With the continuous rotation of the rotating semi-cylindrical panel 1041, the isolation plate 115 is moved down by the pressing plate, and the yam in the storage box 103 slides into the rotating semi-cylindrical panel 1041. When the isolation plate 115 is lower than the storage box 103, the controller 130 controls the stepper motor 1043 to stop; that is, the stepper motor 1043 stops after rotating by 180 degrees clockwise. In this case, the push plate 106 and the baffle 110 are both tangent to the rotating semi-cylindrical panel 1041. Then, the controller 130 controls the first push-rod motor 105 to drive the push plate 106 to move forward. The push plate 106 drives the yam inside the rotating semi-cylindrical panel 1041 to move forward, and at the same time drives the support plate 118 to move forward to provide support at the bottom of the rotating semi-cylindrical panel 1041, so as to prevent the rotating semi-cylindrical panel 1041 from moving when the vertical cutter 108 cuts downward. When a front end of the yam hits the baffle 110, the first photoelectric sensor 111 detects a signal and transfers the signal to the controller 130, and the controller 130 controls the first push-rod motor 105 to stop, and controls the second push-rod motor 107 to drive the vertical cutter 108 to move downward. At the same time, the controller 130 controls the fourth push-rod motor 112 to drive the horizontal cutter 113 to move forward horizontally to cut off a small piece of two ends of the yam. The cutting length of the two ends of the yam is fixed. Upon completion of the cutting, the controller 130 controls the fourth push-rod motor 112 to drive the horizontal cutter 113 to reset, the third push-rod motor 109 drives the baffle 110 to reset, and then, the controller 130 controls the first push-rod motor 105 to drive the vertical cutter 108 to push the yam to continuously move forward. The cut front end of the yam is pushed into the second yam end collection box 121, and then, the yam is pushed out for other processing or collection. Then, the first push-rod motor 105 drives the push plate 106 back. On the return trip, the vertical cutter 108 pulls a cut back end of the yam back and drops it into the first yam end collection box 120, the vertical cutter 108 is reset, and the support plate 118 is reset. When resetting of the support plate 118 is detected by the second photoelectric sensor 119, the controller 130 controls the stepping motor 1043 to continue to rotate by 180 degrees. During rotation of the stepping motor 1043, the isolation plate 115 rises. At the same time, a delay of 3 seconds is generated when the second photoelectric sensor 119 detects that the support plate 118 is reset, and the conveying mechanism 102 continues to work repeatedly, achieving that another yam falls into the storage box 103 and the controller 130 controls each component to repeat the above working process continuously.

The technical solutions of the present invention is explained in detail in combination with the attached drawing above, and the present invention provides a yam two-end removing device. The conveying mechanism 102, the storage box 103, the accommodating portion 104, the photoelectric sensor, the push-rod motor, the cutter or the like are arranged in coordination with each other to remove the two ends of yams with different thicknesses and lengths automatically and efficiently. The yam two-end removing device according to the present invention can cooperate with the existing peeling and cleaning devices to realize the mechanized and automatic processing of yam, which is beneficial to improve the processing quality of yam, and the removed ends can also be reused, which saves resources to a certain extent.

In the present invention, the terms “first,” “second,” and “third” are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

In the description of the specification, the descriptions about the terms “an embodiment,” “some embodiments,” “specific embodiment(s),” and the like mean that specific features, structures, materials or characteristics described in combination with the embodiment(s) or example(s) are included in at least one embodiment or example of the present invention. In the specification, schematic expressions of the above terms do not necessarily refer to the same embodiment or example. Moreover, the specific features, structures, materials or characteristics described may be combined in a suitable manner in any one or more embodiments or examples.

The above are merely preferred embodiments of the present invention and are not intended to limit the present invention. The present invention may be subject to changes and variations for those skilled in the art. Any modifications, equivalent replacements, and improvements made within the spirit and principles of the present invention shall all be encompassed in the protection scope of the present invention.

What is claimed is:

1. A yam two-end removing device, comprises:
a rack;
a conveying mechanism arranged on the rack;
a storage box arranged adjacent to and in coordination with the conveying mechanism, the bottom surface of the storage box tilting downwards;
an accommodating portion arranged adjacent to and in coordination with the storage box, a curved surface side of the accommodating portion being next to the bottom of the storage box for accommodating the yams to cut two ends of a yam;
a first push-rod motor and a push plate connected to and coordinated with each other, arranged on one semicircular opening side of the accommodating portion, the first push-rod motor being fixedly connected to the rack;
a second push-rod motor and a vertical cutter connected to and coordinated with each other, arranged on one side of the push plate toward the accommodating portion, the vertical cutter being driven by the second push-rod motor to move up and down along a vertical direction to cut one end of the yam;
a third push-rod motor and a baffle connected to and coordinated with each other, arranged on the other semicircular opening side of the accommodating portion, the third push-rod motor being fixedly connected to the rack, and a down-facing first photoelectric sensor being arranged in the top middle of the baffle;
a fourth push-rod motor and a horizontal cutter connected to and coordinated with each other, arranged adjacent to the other semicircular opening side of the accommodating portion, the fourth push-rod motor being fixedly connected to the rack, the fourth push-rod motor pushing the horizontal cutter to move back and forth in a horizontal direction to cut away the other end of the yam, and the accommodating portion being provided with a cutter groove matching the horizontal cutter;
a controller connected to the conveying mechanism, the first push-rod motor, the second push-rod motor, the third push-rod motor, the first photoelectric sensor and the fourth push-rod motor respectively.

2. The yam two-end removing device according to claim 1, wherein the accommodating portion comprises:
two rotating semi-cylindrical panels welded opposite to each other on a plain shaft, the plain shaft being rotatably connected to the rack;
a stepping motor connected to the plain shaft, the stepping motor driving the plain shaft to rotate to drive the rotating semi-cylindrical panels to rotate, and the stepping motor being fixedly connected to the rack; and
a pressing plate fixedly connected to two edges of the two rotating semi-cylindrical panels opposite to the conveying mechanism; and
the yam two-end removing device further comprises:
an isolation plate arranged between the storage box and the accommodating portion, a spring loop bar being sleeved with a horizontal end of the isolation plate and being fixedly connected to the rack, the spring loop bar being sleeved with a spring, and a top end of the spring being in contact with the isolation plate.

3. The yam two-end removing device according to claim 2, further comprising:
a support plate fixedly connected to a lower part of the push plate, the support plate being perpendicular to the push plate and extending toward the accommodating portion along the horizontal direction, a height of an extension section of the support plate from the push plate to the accommodating portion being lower than a bottom surface of the accommodating portion, and a horizontal length of the extension section being greater than a horizontal distance from the vertical cutter to the push plate.

4. The yam two-end removing device according to claim 3, further comprising:
a second photoelectric sensor fixedly connected to the rack and oriented toward the support plate.

5. The yam two-end removing device according to claim 1, further comprising:
a first yam end collection box arranged below a gap between the push plate and the semicircular opening side, the first yam end collection box being detachably connected to the rack; and
a second yam end collection box arranged below a gap between the push plate and the semicircular opening side, the second yam end collection box being detachably connected to the rack.

6. The yam two-end removing device according to claim 1, further comprising:
a yam end collection box arranged below the accommodating portion, the two ends of the yam end collection box exceed two ends of the accommodating portion to collect the yam ends pushed down from both ends of the accommodating portion, the yam end collection box being detachably connected to the rack.

7. The yam two-end removing device according to claim 1, wherein the conveying mechanism comprises:
a conveying motor and rollers arranged in coordination, fixedly connected to the rack, the two rollers being arranged at intervals, and the conveying motor being connected to one of the rollers;
a conveyor belt, with which the roller is sleeved, the conveying motor driving the roller to rotate, so as to drive the conveyor belt for transmission, and the conveyor belt being arranged in coordination with the storage box to convey the yam into the storage box.

8. The yam two-end removing device according to claim 7, wherein the conveying mechanism further comprises:
a plurality of partitions arranged at intervals on the conveyor belt;
a third photoelectric sensor arranged on a lower side of the roller adjacent to the storage box, the third photoelectric sensor being oriented toward a bottom part of the conveyor belt, and a vertical distance between the third photoelectric sensor and the lowest surface of the conveyor belt being lower than the height of the partitions.
